(19) United States
(12) Patent Application Publication
(10) Pub. No.: US 2019/0164124 A1
(43) Pub. Date: May 30, 2019

(54) COLD CHAIN INTELLIGENCE FOR CONSUMER MOBILE DEVICES

(71) Applicant: CARRIER CORPORATION, Palm Beach Gardens, FL (US)

(72) Inventors: Marc Beasley, Beverly, MA (US); Ciara Poolman, Syracuse, NY (US); Robert A. Chopko, Baldwinsville, NY (US); John Cronin, Bonita Springs, FL (US); Steven Matthew Philbin, Estero, FL (US)

(21) Appl. No.: 16/318,251

(22) PCT Filed: Jul. 20, 2017
(86) PCT No.: PCT/US2017/043048

§ 371 Date: Jan. 16, 2019

Related U.S. Application Data
(60) Provisional application No. 62/365,665, filed on Jul. 22, 2016.

(51) Int. Cl. G06Q 10/08; G06Q 10/06

(52) U.S. Cl. CPC G06Q 10/0838; G06Q 10/0832; G06Q 10/06395; G06Q 10/0635

(57) ABSTRACT

A system for monitoring perishable goods including: a storage device to store perishable good requirements, producer inputs, safety alerts, consumer parameters, and historical quality parameters associated with the perishable goods; a risk management system coupled to the storage device. The risk management system including: a quality determination module to determine quality levels of the perishable goods in response to at least one of the historical quality parameters and perishable good requirements; a risk determination module to determine risk levels of the perishable goods in response to at least one of the historical quality parameters, perishable good requirements, producer inputs, consumer parameters, and safety alerts; and a meshing module to determine output parameters in response to at least one of the quality levels and the risk levels.

### BACKGROUND OF THE DISCLOSURE

The embodiments disclosed herein generally relate to cold chain distribution systems, and more specifically to an apparatus and a method for monitoring perishable goods.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

Consumers are becoming increasingly concerned with the quality level of the perishable goods they are purchasing, as well as any potential risks associated with the perishable goods. It is often difficult to predict the quality of perishable goods as the perishable goods may change hands several times along the route, thus making it difficult for consumers to gage quality at the time of purchase. It is also often difficult for consumers to assess the risk level of perishable goods they are purchasing. While a food borne illness may only affect a small percentage of the population, the news and social media may stoke panic in the larger population, resulting in overly cautious consumers disposing of perfectly good perishable goods. Improved systems, particularly improved quality tracking and risk level prediction systems would provide benefits to the industry.

### BRIEF DESCRIPTION OF THE DISCLOSURE

According to one embodiment, a system for monitoring perishable goods is provided. The system including: a storage device to store perishable good requirements, producer inputs, safety alerts, consumer parameters, and historical quality parameters associated with the perishable goods; a risk management system coupled to the storage device. The risk management system including: a quality determination module to determine quality levels of the perishable goods in response to at least one of the historical quality parameters and perishable good requirements; a risk determination module to determine risk levels of the perishable goods in response to at least one of the historical quality parameters, perishable good requirements, producer inputs, consumer parameters, and safety alerts; and a meshing module to determine output parameters in response to at least one of the quality levels and the risk levels.

In addition to one or more of the features described above, or as an alternative, further embodiments of the system may include a consumer mobile device configured to transmit the consumer parameters to the storage device and receive output parameters from the meshing module.

In addition to one or more of the features described above, or as an alternative, further embodiments of the system may include a user device configured to transmit the producer inputs to the storage device.

In addition to one or more of the features described above, or as an alternative, further embodiments of the system may include that the output parameters are configured as at least one of a map displaying time-based locations of the perishable goods along with the output parameters at the time-based locations, a data table of output parameters, and a quality levels versus time graph.

In addition to one or more of the features described above, or as an alternative, further embodiments of the system may include a consumer mobile device configured to activate an alarm when the risk level is greater than or equal to a selected risk level.

In addition to one or more of the features described above, or as an alternative, further embodiments of the system may include at least one sensor configured to monitor the historical quality parameters of the perishable goods and transmit the historical quality parameters to the storage device.

In addition to one or more of the features described above, or as an alternative, further embodiments of the system may include that the output parameters include alternative perishable good suggestions when the perishable goods have a risk level greater than or equal to a selected risk level.

According to another embodiment, a method of monitoring perishable goods is provided. The method including: storing, using a storage device, perishable good requirements, producer inputs, safety alerts, consumer parameters, and historical quality parameters associated with the perishable goods; and analyzing, using a risk management system, the perishable good requirements, the producer inputs, the safety alerts, the consumer parameters, and the historical quality parameters. The risk management system coupled to the storage device. The risk management system including: a quality determination module to determine quality levels of the perishable goods in response to at least one of the historical quality parameters and perishable good requirements; a risk determination module to determine risk levels of the perishable goods in response to at least one of the historical quality parameters, perishable good requirements, producer inputs, consumer parameters, and safety alerts; and a meshing module to determine output parameters in response to at least one of the quality levels and the risk levels.

In addition to one or more of the features described above, or as an alternative, further embodiments of the method may include transmitting, using a consumer mobile device, consumer parameters to the storage device.

In addition to one or more of the features described above, or as an alternative, further embodiments of the method may include receiving, using a consumer mobile device, output parameters from the meshing module.

In addition to one or more of the features described above, or as an alternative, further embodiments of the method may include transmitting, using a user device, producer inputs to the storage device.

In addition to one or more of the features described above, or as an alternative, further embodiments of the method may include that the output parameters are configured as at least one of a map displaying time-based locations of the perishable goods along with the output parameters at the time-based locations, a data table of output parameters, and a quality levels versus time graph.

In addition to one or more of the features described above, or as an alternative, further embodiments of the method may include activating, using a consumer mobile device, an alarm when the risk level is greater than or equal to a selected risk level.

In addition to one or more of the features described above, or as an alternative, further embodiments of the method may include monitoring, using at least one sensor, the historical quality parameters of the perishable goods; and transmitting the historical quality parameters to the storage device.

In addition to one or more of the features described above, or as an alternative, further embodiments of the method may include transmitting, using the risk management system, alternative perishable good suggestions to a consumer mobile device when the perishable goods have a risk level above a selected risk level.

According to another embodiment, a computer program product tangibly embodied on a computer readable medium is provided. The computer program product including instructions that, when executed by a processor, cause the processor to perform operations. The operations including: storing, using a storage device, perishable good requirements, producer inputs, safety alerts, consumer parameters, and historical quality parameters associated with the perishable goods; analyzing, using a risk management system, the perishable good requirements, the producer inputs, the safety alerts, the consumer parameters, and the historical quality parameters. The risk management system coupled to the storage device. The risk management system including: a quality determination module to determine quality levels of the perishable goods in response to at least one of the historical quality parameters and perishable good requirements; a risk determination module to determine risk levels of the perishable goods in response to at least one of the historical quality parameters, perishable good requirements, producer inputs, consumer parameters, and safety alerts; and a meshing module to determine output parameters in response to at least one of the quality levels and the risk levels.

In addition to one or more of the features described above, or as an alternative, further embodiments of the computer program may include that the operations further include: receiving, using the storage device, consumer parameters from a consumer mobile device.

In addition to one or more of the features described above, or as an alternative, further embodiments of the computer program may include that the operations further include: transmitting, using the meshing module, output parameters to a consumer mobile device.

In addition to one or more of the features described above, or as an alternative, further embodiments of the computer program may include that the operations further include: receiving, using the storage device, producer inputs from a user device.

In addition to one or more of the features described above, or as an alternative, further embodiments of the computer program may include that the output parameters are configured as at least one of a map displaying time-based locations of the perishable goods along with the output parameters at the time-based locations, a data table of output parameters, and a quality levels versus time graph.

In addition to one or more of the features described above, or as an alternative, further embodiments of the computer program may include that the operations further include: activating, using a consumer mobile device, an alarm when the risk level is greater than or equal to a selected risk level.

In addition to one or more of the features described above, or as an alternative, further embodiments of the computer program may include that the operations further include: monitoring, using at least one sensor, the historical quality parameters of the perishable goods; and transmitting the historical quality parameters to the storage device.

In addition to one or more of the features described above, or as an alternative, further embodiments of the computer program may include that transmitting, using the risk management system, alternative perishable good suggestions to a consumer mobile device, when the perishable goods have a risk level above a selected risk level.

Technical effects of embodiments of the present disclosure include tracking various quality parameters of perishable goods and using the quality parameters to determine the current quality of the perishable goods and predict risk levels of the perishable goods.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for monitoring perishable goods, according to an embodiment of the present disclosure;

FIG. 2 illustrates a schematic view of a cold chain distribution system that may incorporate embodiments of the present disclosure; and

FIG. 3 is a flow diagram illustrating a method of monitoring perishable goods, according to an embodiment of the present disclosure.

### DETAILED DESCRIPTION OF THE DISCLOSURE

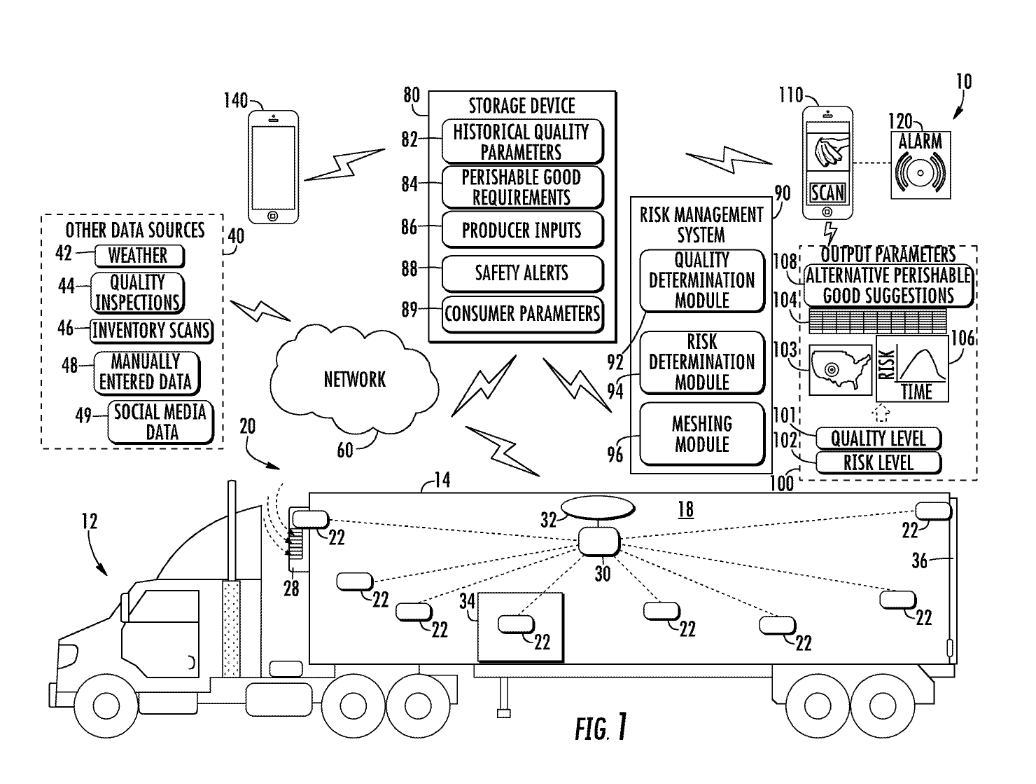

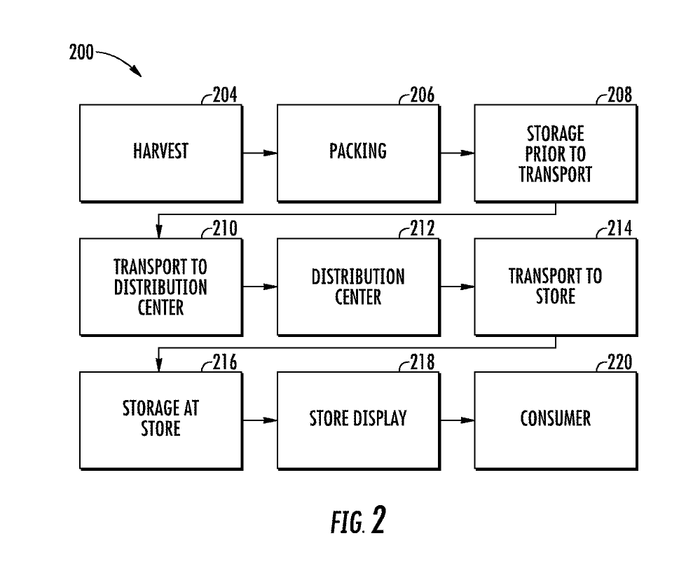

Referring now to the drawings, FIG. 1 illustrates a schematic view of a system 10 for monitoring perishable goods 34, according to an embodiment of the present disclosure. FIG. 2 illustrates a schematic view of a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes an environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example, temperature, pressure, humidity, carbon dioxide, ethylene, ozone, light exposure, vibration exposure, and other conditions to the interior compartment 18. In further embodiments, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22, which may be hardwired or wireless. The sensors 22 may be utilized to monitor historical quality parameters 82 of the perishable goods 34. The historical quality parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the desired historical quality parameters 82. Advantageously, sensors 22 may be selected for certain applications depending on the type of perishable goods 34 to be monitored and the corresponding environmental sensitivities. In an embodiment, temperatures are monitored. As seen in FIG. 1, the sensors 22 may be placed directly on the perishable goods 34.

The sensors 22 may be placed in a variety of locations including but not limited to on the transport refrigeration unit 28, on a door 36 of the container 14 and throughout the interior compartment 18. The sensors 22 may be placed directly within the transport refrigeration unit 28 to monitor the performance of the transport refrigeration unit 28. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34. Additionally, a global positioning system (GPS) location may also be detected by the sensors 22. The GPS location may help in providing time-based location information for the perishable goods 34 that will help in tracking the travel route and other historical quality parameters 82 along that route. For instance, the GPS location may also help in providing information from other data sources 40 regarding weather 42 experienced by the container 14 along the travel route. The local weather 42 affects the temperature of the container 14 and thus may affect the temperature of the perishable goods 34.

As illustrated in FIG. 1, the transport refrigeration system 20 may further include, a controller 30 configured to log a plurality of readings from the sensors 22, known as the historical quality parameters 82, at a selected sampling rate. The controller 30 may be enclosed within the transport refrigeration unit 28 or separate from the transport refrigeration unit 28 as illustrated. The historical quality parameters 82 may further be augmented with time, location stamps or other relevant information. The controller 30 may also include a processor (not shown) and an associated memory (not shown). The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in wireless operative communication with a network 60. The communication module 32 is configured to transmit the historical quality parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface. The short range interface includes at least one of: a wired interface, an optical interface, and a short range wireless interface.

Historical quality parameters 82 may also be provided by other data sources 40, as illustrated in FIG. 1. These other data sources 40 may be collected at any point throughout the cold chain distribution system 200, which as illustrated in FIG. 2 may include harvest 204, packing 206, storage prior to transport 208, transport to distribution center 210, distribution center 212, transport to store 214, storage at store 216, store display 218 and consumer 220. These stages are provided for illustrative purposes and a distribution chain may include fewer stages or additional stages, such as, for example, a cleaning stage, a processing stage, additional transportation stages, and a consumer stage when the consumer is in possession of the perishable good 34. The other data sources 40 may include, but are not limited to, weather 42, quality inspections 44, inventory scans 46, manually entered data 48, and social media data. The weather 42, as discussed above, has an effect on the operation of the transport refrigeration unit 28 by influencing the temperature of the container 14 during transport (e.g., 210 and 214) but the weather 42 also has other influences on the transport refrigeration unit 28. For instance, the weather 42 prior to and at harvest 204 may have an impact on the quality of the perishable goods 34. Moreover, quality inspections 44, similar to the weather 42, may reveal data of the perishable goods 34 that affects quality. For instance, a particular batch of strawberries was subjected to rainfall just prior to harvest 204, making them prone to spoilage. Quality inspections 44 may be done by a machine or a human being. Quality inspections 44 performed by a machine may be accomplished using a variety of techniques including but not limited to optical, odor, soundwave, infrared, or physical probe. Historical quality parameters 82 may also be collected from social media data 49 from social media sources, such as, for example Facebook, Twitter, Instagram, LinkedIn, Myspace, Google+, and similar networks. The social media data 49 may be processed using text mining and other machine learning techniques to detect trending patterns for particular perishable goods 34 in particular locations. For instance, “#BadStrawberries” may be trending on social media in New England, which may help identify the source of the strawberries and aid in risk level 102 determinations, discussed further below.

Further, inventory scans 46 may also reveal historical quality parameters 82 about the perishable goods 34 and may help in tracking the perishable goods 34. For instance, the inventory scan 46 may reveal the time, day, truck the perishable goods arrived on, which may help identify the farm if previously unknown. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device known to one of skill in the art.

Historical quality parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Historical quality parameters 82 may further include attributes of the perishable goods 34 such as, for example, temperature, weight, size, sugar content, maturity, grade, ripeness, labeling, and packaging. For instance, strawberries may be packaged in 1 pound clamshells, be a certain weight or grade, be organic, and have certain packaging or labels on the clamshells. Historical quality parameters 82 may also include information regarding the operation of the environmental control unit 28, as discussed above. The historical quality parameters 82 may further be augmented with time, location stamps or other relevant information.

In the illustrated embodiment, the system 10 further includes a storage device 80 to store the historical quality parameters 82 associated with the perishable goods 34 of a distribution chain. At least one of the historical quality parameters 82 may be received from a transport refrigeration system 20. The storage device 80 is connected to the communication module 32 through the network 60. As shown, the storage device 80 also stores consumer parameters 89. The storage device 80 may be but is not limited to a random access memory (RAM), read only memory (ROM), or other electronic, optical, magnetic or any other computer readable medium. The storage device may also store perishable good requirements 84, producer input 86, and safety alerts 88, as discussed below.

In the illustrated embodiment, the system 10 further includes a risk management system 90. The risk management system 90 is connected to the communication module 32 through the network 60. The risk management system 90 is also coupled to the storage device 80. As shown, the risk management system 90 includes a quality determination module 92, a risk determination module 94, and a meshing module 96. The risk management system 90 may also include a processor (not shown) and an associated memory (not shown). The associated memory may be the storage device 80. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The quality determination module 92, the risk determination module 94, and the meshing module 96 may be implemented in software as applications executed by the processor of risk management system 90.

The quality determination module 92 determines quality levels 101 of the perishable goods 34 in response to at least one of the historical quality parameters 82 and the perishable good requirements 84. The risk determination module 94 determines risk levels 102 of the perishable goods 34 in response to historical quality parameters 82, perishable good requirements 84, producer inputs 86, consumer parameters 89, and safety alerts 88. The perishable good requirements 84 may be requirements for handling and/or packaging the perishable good 34 such as, for example, government regulations or industry standards. The risk level 102 associated with the perishable good 34 may increase if some of the historical quality parameters 82 do not satisfy the perishable good requirements 84. In one example, the risk level 102 may increase due to the perishable goods 34 being kept at elevated temperatures during transportation, which is recorded as a perishable good parameter 84. In a second example, there might be a recall of a perishable good 34 which may raise the risk level 102. The risk level 102 may rise even higher if the consumer is in a particular location of elevated risk. In a third example, the risk level 102 may increase if the producer inputs 86 do not satisfy the perishable good requirements 84. Producer inputs 86 are data inputs from the producer to confirm that they are satisfying the perishable good requirements 86. The producer may be a producer or receiver of the perishable goods 34, such as, for example, a farmer, a butcher, a fisherman, a hunter, a scavenger, or a store owner. The producer enters the producer inputs 86 via a user device 140 to confirm the producer is meeting the perishable good requirements 84. For example, the producer may need to confirm that they are meeting the perishable good requirements 84 to be certified organic. The user device 140 may be a device such as, for example, a cellular phone, tablet, laptop, smartwatch, desktop computer, or any similar device. Safety alerts 88 may be alerts such as, for example, recalls and disease outbreaks.

Consumer parameters 89 may include information regarding: the geolocation of the consumer at the time of purchasing the perishable goods 34, the specific store 218 where the perishable goods 34 were purchased, the time when the perishable goods 34 were purchased, the type of perishable goods 34 (ex: bananas), and the brand of perishable goods 34. Some of the consumer parameters 89 may be collected passively (i.e. passive transmission) by a consumer mobile device 110 such as, for example, tracking the time and location of the consumer at the time the perishable goods 34 were purchased. Conversely, some consumer parameters 89 may have to be actively entered (i.e. active transmission) into a consumer mobile device 110, such as, for example, consumer preferences on a type of perishable good 34 and a brand of perishable goods 34. Further, some consumer parameters 89 may be collected automatically (i.e. automatic transmission) when the consumer scans an ID tag of the perishable goods 34 with their consumer mobile device 110, such as, for example, the type of perishable goods 34 and the brand of perishable goods 34. The ID tag may be a Universal Product Code (UPC) bar code, Quick Response (QR) code, or another identification methodology known to one of skill in the art. If an ID tag is not available these consumer parameters 89 may be entered manually. The consumer mobile device 110 may be a device such as, for example, a cellular phone, tablet, laptop, smartwatch, or any similar mobile device. Further, consumer parameters 89 may also include preferences set by the consumer, such as, for example, the consumer's own selected risk level. For example, some consumers, such as young children, the elderly and those with suppressed immune systems would benefit from being able to select their own risk level considering they cannot tolerate as much risk as the average consumer. Thus, utilizing consumer parameters 89 such as the selected risk level, the risk management system 90 could be tailored to meet the individuality of each consumer.

The meshing module 96 determines output parameters 100 in response to at least one of the quality levels 101 and the risk levels 102. In an embodiment, the output parameters 100 may include the quality levels 101 of the perishable goods 34 at a particular time and location. The output parameters 100 may be accessible via the consumer mobile device 110 and/or sent directly to the consumer mobile device 110. The output parameters 100 may be configured as at least one of a map 103 displaying time-based locations of the perishable goods 34 along with the output parameters 100 at the time-based locations, a data table 104 of output parameters 100, a quality level 101 versus time graph 106, a text write-up (not shown), or any other method of displaying output parameters known to one of skill in the art. The output parameters 100 may also include alternative perishable good suggestions 108 when the risk level 102 of the perishable good 34 is greater than or equal to a selected risk level 102. The risk management system 90 may be able to recommend an alternative perishable good suggestion 108 that is below the selected risk level through the consumer mobile device 110. For instance, if one brand of bananas is being recalled, the alternative perishable good suggestions 108 may recommend another brand.

The consumer may be able to enter in some information into their consumer mobile device 110 or scan the ID tag of the perishable good 34 and immediately have access to output parameters 100 that detail the entire journey of the perishable good 34 from harvest 204 to consumer 220 and quality along the journey. For instance, the consumer may be able to see the route the perishable goods 34 had taken from farm-to-fork and the quality level 101 of the perishable goods 34 throughout that route. The consumer mobile device 110 is configured to activate an alarm 120 when the risk level of a perishable good 34 is greater than or equal to a selected risk level. The consumer mobile device 110 may activate the alarm 120 when the consumer enters the consumer parameters 89 using the consumer mobile device 110. Alternatively, the consumer parameters 89 are saved in the storage device 80 and the consumer mobile device 110 may activate the alarm 120 at a later time when the risk level reaches the selected level. For example, a recall may be issued after the perishable good 34 is purchased, and logged as a safety alert 88, the risk management system 90 will realize that the consumer has purchased a recalled perishable good 34 and command the consumer mobile device 110 to issue an alarm 120. The alarm 120 may be audible and/or visual.

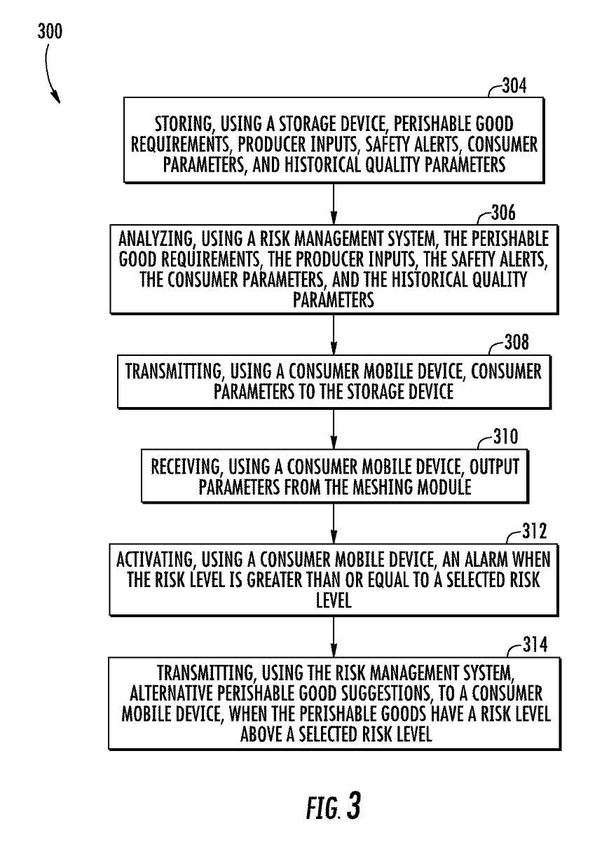

Referring now also to FIG. 3, which shows a flow diagram illustrating a method 300 of monitoring perishable goods 34, according to an embodiment of the present disclosure. At block 304, the storage device 80 stores perishable good requirements 84, producer inputs 86, safety alerts 88, consumer parameters 89, and historical quality parameters 82 associated with the perishable goods 34. At block 306, the risk management system 90 analyzes the perishable good requirements 84, the producer inputs 86, the safety alerts 88, the consumer parameters 89, and the historical quality parameters 82. The risk management system 90 is coupled to the storage device 80. As described above, the risk management system 90 includes: a quality determination module 92 to determine quality levels 101 of the perishable goods 34 in response to at least one of the historical quality parameters 82 and perishable good requirements 84; a risk determination module 94 to determine risk levels 102 of the perishable goods 34 in response to at least one of the historical quality parameters 82, perishable good requirements 84, producer inputs 86, consumer parameters 89, and safety alerts 88; and a meshing module 96 to determine output parameters 100 in response to at least one of the quality levels 101 and the risk levels 102.

Further, at block 308, the consumer mobile device 110 may transmit consumer parameters 89 to the storage device 80. At block 310, the consumer mobile device 110 may receive output parameters 100 from the meshing module 96. At block 312, the consumer mobile device 110 may activate an alarm 120 when the risk level 102 is greater than or equal to a selected risk level. At block 314, the risk management system 90 may transmit alternative perishable good suggestions 108 to the consumer mobile device 110 when the risk level 102 is greater than or equal to a selected risk level. The method 300 may also include the user device 140 transmitting producer inputs 86 to the storage device 80.

While the above description has described the flow process of FIG. 3 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for monitoring perishable goods, the system comprising:
a storage device to store perishable good requirements, producer inputs, safety alerts, consumer parameters, and historical quality parameters associated with the perishable goods; and
a risk management system coupled to the storage device, the risk management system including:
a quality determination module to determine quality levels of the perishable goods in response to at least one of the historical quality parameters and perishable good requirements;
a risk determination module to determine risk levels of the perishable goods in response to at least one of the historical quality parameters, perishable good requirements, producer inputs, consumer parameters, and safety alerts; and
a meshing module to determine output parameters in response to at least one of the quality levels and the risk levels.

2. The system of claim 1, further comprising:
a consumer mobile device configured to transmit the consumer parameters to the storage device and receive output parameters from the meshing module.

3. The system of claim 1, further comprising:
a user device configured to transmit the producer inputs to the storage device.

4. The system of claim 1, wherein:
the output parameters are configured as at least one of a map displaying time-based locations of the perishable goods along with the output parameters at the time-based locations, a data table of output parameters, and a quality levels versus time graph.

5. The system of claim 1, further comprising:
a consumer mobile device configured to activate an alarm when the risk level is greater than or equal to a selected risk level.

6. The system of claim 1, further comprising:
at least one sensor configured to monitor the historical quality parameters of the perishable goods and transmit the historical quality parameters to the storage device.

7. The system of claim 1, wherein:
the output parameters include alternative perishable good suggestions when the perishable goods have a risk level greater than or equal to a selected risk level.

8. A method of monitoring perishable goods, the method comprising:
storing, using a storage device, perishable good requirements, producer inputs, safety alerts, consumer parameters, and historical quality parameters associated with the perishable goods; and
analyzing, using a risk management system, the perishable good requirements, the producer inputs, the safety alerts, the consumer parameters, and the historical quality parameters, the risk management system coupled to the storage device, the risk management system including:
a quality determination module to determine quality levels of the perishable goods in response to at least one of the historical quality parameters and perishable good requirements;
a risk determination module to determine risk levels of the perishable goods in response to at least one of the historical quality parameters, perishable good requirements, producer inputs, consumer parameters, and safety alerts; and
a meshing module to determine output parameters in response to at least one of the quality levels and the risk levels.

9. The method of claim 8, further comprising:
transmitting, using a consumer mobile device, consumer parameters to the storage device.

10. The method of claim 8, further comprising:
receiving, using a consumer mobile device, output parameters from the meshing module.

11. The method of claim 8, further comprising:
transmitting, using a user device, producer inputs to the storage device.

12. The method of claim 8, wherein:
the output parameters are configured as at least one of a map displaying time-based locations of the perishable goods along with the output parameters at the time-based locations, a data table of output parameters, and a quality levels versus time graph.

13. The method of claim 8, further comprising:
activating, using a consumer mobile device, an alarm when the risk level is greater than or equal to a selected risk level.

14. The method of claim 8, further comprising:
monitoring, using at least one sensor, the historical quality parameters of the perishable goods; and
transmitting the historical quality parameters to the storage device.

15. The method claim 8, further comprising:
transmitting, using the risk management system, alternative perishable good suggestions to a consumer mobile device when the perishable goods have a risk level above a selected risk level.

16. A computer program product tangibly embodied on a computer readable medium, the computer program product including instructions that, when executed by a processor, cause the processor to perform operations comprising:
storing, using a storage device, perishable good requirements, producer inputs, safety alerts, consumer parameters, and historical quality parameters associated with the perishable goods; and
analyzing, using a risk management system, the perishable good requirements, the producer inputs, the safety alerts, the consumer parameters, and the historical quality parameters, the risk management system coupled to the storage device, the risk management system including:
a quality determination module to determine quality levels of the perishable goods in response to at least one of the historical quality parameters and perishable good requirements;
a risk determination module to determine risk levels of the perishable goods in response to at least one of the historical quality parameters, perishable good requirements, producer inputs, consumer parameters, and safety alerts; and
a meshing module to determine output parameters in response to at least one of the quality levels and the risk levels.

17. The computer program of claim 16, wherein the operations further comprise:
receiving, using the storage device, consumer parameters from a consumer mobile device.

18. The computer program of claim 16, wherein the operations further comprise:
transmitting, using the meshing module, output parameters to a consumer mobile device.

19. The computer program of claim 17, wherein the operations further comprise:
receiving, using the storage device, producer inputs from a user device.

20. The computer program of claim 16, wherein:
the output parameters are configured as at least one of a map displaying time-based locations of the perishable goods along with the output parameters at the time-based locations, a data table of output parameters, and a quality levels versus time graph.

21. (canceled)

22. (canceled)

23. (canceled)
